(19) United States
(12) Patent Application Publication
(10) Pub. No.: US 2005/0197804 A1
(43) Pub. Date: Sep. 8, 2005

(54) System and method for continuously recording user actions and displayed images

(76) Inventor: Simon J. Reeves, Uxbridge (GB)

Correspondence Address: Eunhee Park;Baker & McKenzie, 29th Floor, 805 Third Avenue, New York, NY, 10022, US

(21) Appl. No.: 10/795,528

(22) Filed: Mar. 8, 2004

(51) Int. Cl. G06F 15/00

(52) U.S. Cl. 702/187

(57) ABSTRACT

A system and method for continuously recording user actions and displayed images on a computer device is provided. A recorder box service in one aspect continuously captures video images from a video driver. Optionally, mouse inputs from a mouse driver and keyboard inputs from a keyboard driver may be captured. The captured information is written in a footage file. The user actions and display images may be replayed by using the footage file.

### TECHNICAL FIELD

This application relates to computer systems generally, and particularly to a recording system and method that continuously records user actions and displayed images.

### BACKGROUND

Users of computer systems frequently desire to retrack their actions to determine what course of actions the users followed to arrive at certain results. For instance, a user who cannot recall where the file that the user was working with is located may wish to retrack the user's actions to determine where the user saved the file last.

The currently available session recording technology utilizes a remote control session ability for viewing glimpses of user actions. Accordingly, a system and method are desirable for allowing the recording of actions and display images continuously without a remote control session.

### SUMMARY

A system and method for continuously recording user actions and displayed images are provided. The system for recording user actions and displayed images, in one aspect, includes a recorder service module operable to capture one or more events from one or more devices associated with a computer. The captured events are recorded in a footage file. The footage file has a predetermined configuration, for instance, a predetermined size or duration for keeping the recorded events. A replayer module is operable to replay the captured events stored in the footage file.

A method of recording user actions and displayed images, in one aspect, includes continuously capturing events from one or more devices in a computer, recording the captured events in a file, maintaining the file according to a predetermined configuration, and allowing the captured events to be replayed using the file.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is an architectural diagram that illustrates a system of the present disclosure in one embodiment.

FIG. 2 is a system diagram that illustrates the components of the present disclosure in one embodiment.

FIG. 3 is a flow diagram illustrating the method of the present disclosure.

FIG. 4 is an example of a system tray icon in one embodiment.

FIG. 5 is an example of a menu listing options for controlling the recording service in one embodiment.

### DETAILED DESCRIPTION

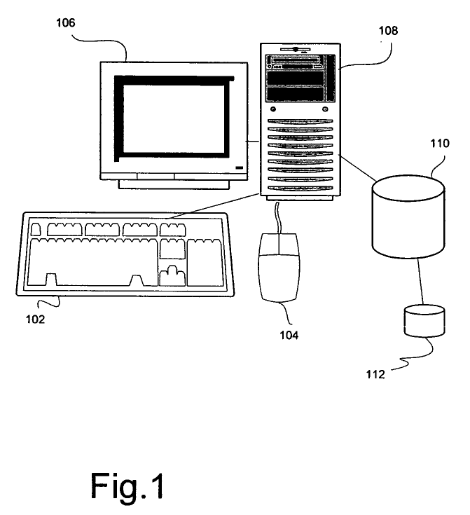

FIG. 1 is an architectural diagram that illustrates a system of the present disclosure in one embodiment. In one embodiment, a service running on the desktop computer 108 constantly records screen 106 events to a footage file 110. The service may also record the mouse 104 and/or keyboard 102 events. The footage file 110, in one embodiment, is managed so that when the file 110 reaches a predetermined size or age, the oldest events are discarded first, for example, to a recycle bin 112. Any other file management scheme may be used to maintain the file.

At any time, the user may replay the footage of the file 110. In one embodiment, the recording is suspended while the replay occurs. Optionally, the user may archive the current footage file 110, for example, for storing into a file whose contents do not automatically get overwritten. The footage file 110 typically is saved or written on a hard disk drive, computer memory, or any other known computer storage device.

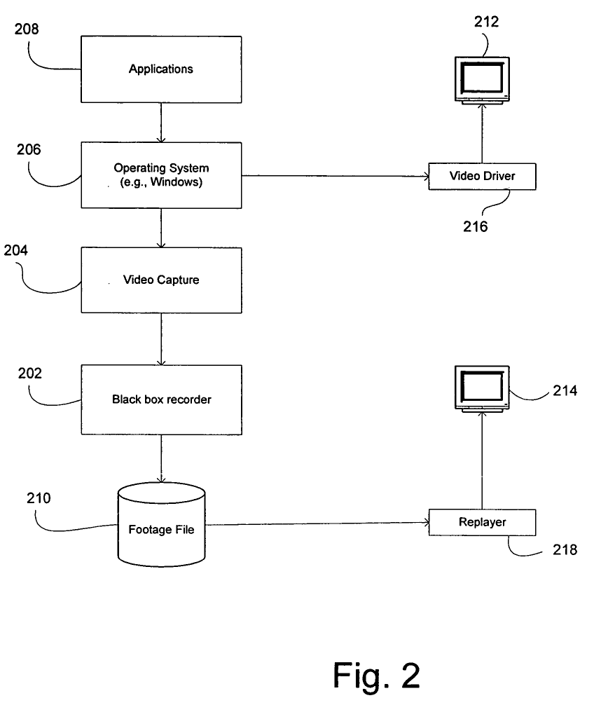

FIG. 2 is a system diagram that illustrates the components of the present disclosure in one embodiment. Applications 208 may include user applications that run on a user's computer. The outputs of these applications 208 may be recorded by a black box recorder 202. The applications 208 provide instructions to the operating system 206, for example, to draw or display images such as windows, icons, text, and graphics, on a computer's display device 212. The operating system 206 instructs a video driver 216 to draw these images onto a physical display device such as a monitor 212. The images are then displayed as screens and windows that a user recognizes.

In one embodiment, the operating system commands sent to the video driver 216 are mirrored in a video capture driver 204. The video capture driver 204 may include a buffer that is shared with the black box recorder service 202. The video driver instructions written in the buffer may be copied to or retrieved by the black box recorder service 202.

For example, the video capture driver 204 is responsible for capturing the drawing that occurs on the computer and encoding the drawing operations into the proprietary video data format. On Win2K/XP platforms this is implemented as a mirror driver in one embodiment. A mirror driver is a display driver for a virtual device. It mirrors the drawing operation of one or more additional physical display devices. A person of ordinary skill in driver technology would typically use Microsoft's driver development kit (DDK) to develop such a mirror driver.

A black box recorder 202, in one embodiment, is a persistent service that is started when the computer starts. The black box recorder 202 receives video information from the video capture driver 204 and stores the video information. The video information may be processed into an efficient form such as optimized or compressed format. The video information formatted into an efficient form may be written in a footage file 210.

In one embodiment, the information written in the footage file 210 may also include a time stamp of each event or discrete information stream. Storing the time stamp associated with the time, at which each event occurred, allows the replay to reproduce the displayed events at the same speed as they occurred when recorded. Users may also be given an option to reproduce the displayed events at a desired speed.

A replayer 214 plays back the user actions or image displays by processing the stream of information that was written in the footage file 210. The replayer 218 may be started at any time. In one embodiment, the recording in the black box recorder is suspended before the replayer 218 is started. The replayer 210 opens the footage file 210 and processes the information stored in the footage file 210 such as the graphical commands. The graphical commands are used to render a reproduction screen displays onto a window. The user may have VCR/DVD style controls to control the replaying speed, location, etc.

To illustrate an example, the footage file 210 may contain a sequence of commands or instructions retrieved or received from the video capture driver 204. The replayer 218 is able to interpret the sequence of instructions in the footage file 210 to render a reproduction in a window or display device 212. An example of the footage file content may be: Time 00:05:00 x,y font Arial “hello”. The replayer 218 processes this command by writing “hello” using the Arial font at x, y coordinates, 5 seconds into the replay sequence.

In one embodiment, the replayer 218 may be implemented as a window application. A window may be created that is the canvas for redrawing the events in the footage file 210.

The black box service 202, also referred to in the present disclosure as the black box recorder is a service that, in one embodiment, is always running on the desktop computer. In one embodiment, the black box service 202 may be started when the computer is started or the footage capture may start when a user logs on. The footage file is then continuously monitored so that the allocated or predetermined file size is not exceeded or a predetermined duration of footage is retained.

In one embodiment, a user may start, stop, suspend the recording, and start a replay. The whole or part of the footage may be archived so that the footage may be saved in more permanent storage.

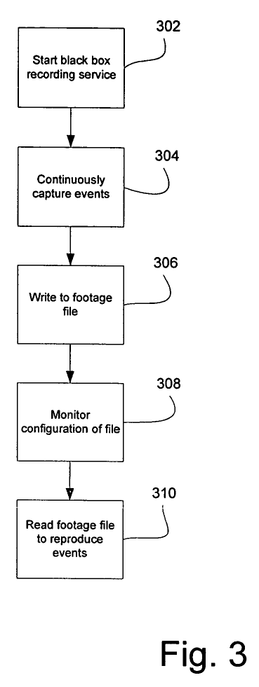

FIG. 3 is a flow diagram illustrating the method of the present disclosure. At 302, the black box recording service is started, for example, when a computer is started or when a user logs on the computer. The events or instructions sent to the device drivers such as the video driver are then captured at 304. The capturing of the events may be done by a mirroring the commands sent to the device driver or hooking into the device drivers. In one embodiment, the capturing is performed continuously as the computer is running.

At 306, the captured events or instructions are written to a footage file. At 308, the footage file is monitored for its size and age. The monitoring of the footage file need not be in sequence to a particular step described in FIG. 3. Rather, the monitoring may be performed concurrently or periodically with the steps described in FIG. 3. At 310, if a replay function is desired, the footage file is read to reproduce the events.

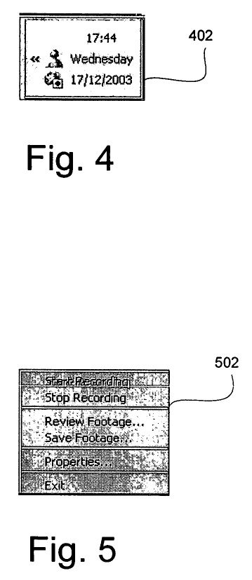

The black box service's existence and state may be displayed by an icon in the desktop's system tray (402 FIG. 4). For instance, while the icon (402 FIG. 4) is showing the recording icon all users' activities may be recorded to a footage file.

The activities recorded may include images displayed on a screen, and optionally keyboard events, and mouse events. Other input events such as the voice input devices, touch screen devices, or any other input devices that may be introduced may also be recorded. The video capture driver 204 may hook into anyone of these devices to capture the events occurring in the respective drivers. Briefly, hooking refers to the procedure of replacing an existing function call with a call to another function, which can call the original (hooked) function itself. The hooking function can process the data that would have been passed to the hooked function before passing it on, if needed.

To maintain the footage file to a manageable size, for example, to prevent it from growing too big, the system and method of the present disclosure allows for configurable size or duration. For instance, a user may be able to configure the maximum size of the footage file such as 200 megabytes. As another example of a configurable footage file, a user may be able to specify the duration of recorded footage that is maintained. For example, user may specify that last 20 minutes of recorded footage may be maintained. When the footage file reaches these limits, the portion of the file is overwritten to accommodate the additional data. For example, a first-in-first out method that discards the oldest information in the file may be used.

The system and method of the present disclosure may also include a mechanism for controlling the black box recorder. In one embodiment, right clicking on the recording icon in the system tray (402 FIG. 4) may display a context menu options such as stop recording, start recording, save footage, review footage, properties, and exit (502 FIG. 5).

The stop recording option stops the service from recording footage. The icon in the system tray (402 FIG. 4) changes to highlight that the service is not recording. The start recording option restarts recording, for instance, if the recording was stopped. The save footage option allows the user to save a copy of the footage file, for example, on a storage device such as a hard or floppy disks.

The review footage option initiates the replay. A temporary copy of the footage file is made and a footage replayer application is launched. This application, in one embodiment, has VCR style controls so that the user can play, rewind, and review their previous actions. The temporary copy is taken so that when the user replays the footage they do not find themselves watching footage of the replayer replaying the footage.

The properties option launches a dialog that allows the user to configure the behavior of the black box service. Configurable properties include the size of the footage file and the duration for recording. The exit option stops the black box recording service from running.

The system and method of the present disclosure may be implemented and run on a general-purpose computer. The embodiments described above are illustrative examples and it should not be construed that the present invention is limited to these particular embodiments. Thus, various changes and modifications may be effected by one skilled in the art without departing from the spirit or scope of the invention as defined in the appended claims.

1. A method of recording user actions and displayed images, comprising:
continuously capturing events from one or more devices in a computer;
recording the captured events in a file;
maintaining the file according to a predetermined configuration; and
allowing the captured events to be replayed using the file.

2. The method of claim 1, wherein the continuously capturing the events includes continuously capturing the events from one or more device drivers associated with the one or more devices.

3. The method of claim 1, wherein the one or more devices include one or more input devices or one or more output devices or combinations thereof.

4. The method of claim 1, wherein the one or more devices include a video device, a mouse device, or a keyboard device, or combinations thereof.

5. The method of claim 1, further including allowing users to configure the predetermined configuration.

6. The method of claim 5, wherein the predetermined configuration include a size of the file, a duration for keeping the recorded events in the file, or combinations thereof.

7. The method of claim 1, further including:
allowing at least a part of the file to be saved.

8. The method of claim 1, wherein the allowing the captured events to be replayed includes making a copy of the file and launching a replayer to replay using the copy of the file.

9. The method of claim 1, further including allowing the continuously capturing to be suspended for a predetermined duration, to be stopped, or to be restarted, or combinations thereof.

10. The method of claim 1, further including displaying a status of the continuously capturing.

11. The method of claim 10, wherein the displaying includes providing a system tray having icons to display the status.

12. A program storage device readable by machine, tangibly embodying a program of instructions executable by the machine to perform method of recording user actions and displayed images, comprising:
continuously capturing events from one or more devices in a computer;
recording the captured events in a file;
maintaining the file according to a predetermined configuration; and
allowing the captured events to be replayed using the file.

13. The program storage device of claim 12, wherein the continuously capturing the events includes continuously capturing the events from one or more device drivers associated with the one or more devices.

14. The program storage device of claim 12, wherein the one or more devices include one or more input devices or one or more output devices or combinations thereof.

15. The program storage device of claim 12, wherein the one or more devices include a video device, a mouse device, or a keyboard device, or combinations thereof.

16. The program storage device of claim 12, further including allowing users to configure the predetermined configuration.

17. A system for recording user actions and displayed images, comprising:
a recorder service module operable to capture one or more events from one or more devices associated with a computer;
a footage file having a predetermined configuration, the footage file for storing the captured events; and
a replayer module operable to replay the capture events stored in the footage file.

18. The method of claim 1, wherein the recording the captured events in a file includes:
recording the captured events in a file with time stamps associated with the captured events.

19. The method of claim 18, wherein the allowing the captured events to be replayed using the file includes:
allowing the captured events to be replayed using the file at a selected speed.
